(19) United States
(12) Patent Application Publication
(10) Pub. No.: US 2026/0328345 A1
(43) Pub. Date: Oct. 22, 2026

(54) Container for Storing Hydrogen in a Solid State

(71) Applicant: 3D4MEC SRL, Sasso Marconi (IT)

(72) Inventors: Ivano Corsini, Sasso Marconi (IT); Andrea Gatto, Sasso Marconi (IT)

(73) Assignee: 3D4MEC SRL, Sasso Marconi (IT)

(21) Appl. No.: 19/486,281

(22) PCT Filed: May 21, 2024
(86) PCT No.: PCT/IB2024/054928

§ 371 Date: Nov. 20, 2025

(30) Foreign Application Priority Data
May 22, 2023 (IT) 102023000010341

(51) Int. Cl. F17C 11/00; B33Y 80/00; C01B 3/0031; C01B 3/0084

(52) U.S. Cl. CPC F17C 11/005; B33Y 80/00; C01B 3/0031; C01B 3/0084; F17C 2201/0119; F17C 2203/0619; F17C 2203/0639; F17C 2221/012; F17C 2227/0304

(57) ABSTRACT

A container for storing hydrogen in a solid state, having a storage body made of metal for storing hydrogen in the form of metal hydride, a casing, which contains the storage body and has an opening for hydrogen injection and extraction in gaseous form, and at least one heating band arranged in the thickness of the casing or around the casing for heating the storage body so as to allow a chemical capture reaction and a chemical release reaction of the hydrogen by the storage body. The storage body may be made of magnesium doped with magnesium fluoride and may have a lattice structure defined by a plurality of elementary cells having the same shape as a three-dimensional gyroid.

### CROSS-REFERENCE TO RELATED APPLICATIONS

This Patent Application claims priority from Italian Patent Application No. 102023000010341 filed on May 22, 2023, the entire disclosure of which is incorporated herein by reference.

### TECHNICAL FIELD

The present invention relates to a container for storing hydrogen in metal hydride form.

In particular, the present invention finds advantageous, but not exclusive application in storage containers comprising magnesium bodies for the storage of hydrogen in the solid state in the form of magnesium hydride, to which the following description will make explicit reference without thereby losing generality.

### BACKGROUND

As is well known, the storage of hydrogen in a gaseous or liquid state presents considerable critical issues. The storage of hydrogen in the gaseous state requires special and expensive high-pressure tanks (up to 700 bar). The storage of hydrogen in the liquid state requires a considerable amount of energy for the liquefaction process and maintenance in the liquid state and has a certain rate of hydrogen loss through evaporation.

The storage of hydrogen in the solid state through the formation of metal hydrides can overcome the critical issues of storing hydrogen in the gaseous or liquid state. Solid-state hydrogen storage is reversible, i.e. the metal can capture and release hydrogen under appropriate pressure and temperature conditions.

Of all the metal hydrides known to be used for hydrogen storage, magnesium hydride has the highest hydrogen storage capacity. However, the reactions of hydrogen capture and release by magnesium alloys, besides requiring high temperatures, are rather slow. Furthermore, given a certain magnesium body in contact with hydrogen gas, the formation of magnesium hydride stops at a certain depth from the surface of the magnesium body, which does not normally exceed 50 μm, i.e. the magnesium hydride on the magnesium body does not normally exceed 50 μm.

### SUMMARY

The purpose of the present invention is to provide a container that allows efficient storage of hydrogen in the form of magnesium hydride, which is free from the drawbacks described above and, at the same time, is easy and inexpensive to manufacture.

In accordance with the present invention, a container is provided for the storage of hydrogen in the solid state, as defined in the appended claims.

The claims describe preferred embodiments of the present invention to be considered an integral part of this description.

### BRIEF DESCRIPTION OF THE DRAWINGS

The present invention will now be described with reference to the accompanying drawings, which show a non-limiting embodiment thereof, wherein:

FIG. 1 illustrates, according to a front perspective view in which parts have been removed for illustrative clarity, a 3D printer for producing a magnesium body for the container of the present invention;

FIG. 2 illustrates the diagram of a gas supply system for the 3D printer in FIG. 1;

FIG. 3 illustrates, in a partially cross-sectional view, a container for storing hydrogen in a solid state of the present invention; and

FIG. 4 illustrates an elementary cell of the structure of the internal body of the container in FIG. 3.

### DESCRIPTION OF EMBODIMENTS

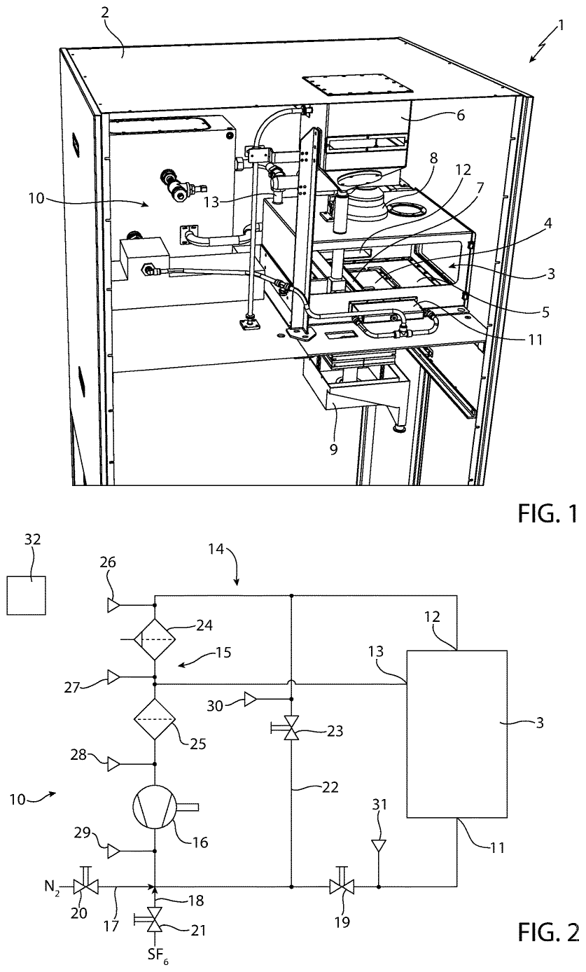

In FIGS. 1, 1 generically refers to a laser powder bed fusion 3D printer for producing a magnesium body.

The 3D printer 1 comprises a support frame 2, a printing chamber 3 fixed to the support frame 2, a build plate 4, which is vertically movable and faces an opening of a horizontal reference plane 5 of the printing chamber 3, a powder feeder 6 for feeding magnesium powder to the printing chamber 3, a spreader 7 arranged in the printing chamber 3 for spreading the magnesium powder to form a layer on the build plate 4, a laser head 8 movable parallel to the reference plane 5 for sintering the magnesium powder layer on the build plate 4 by emitting a laser beam, and a powder collection system 9, which is arranged at the reference plane 5, has a compartment (not visible) in which the build plate 4 slides vertically and is adapted to collect the non-sintered magnesium powder around the magnesium body at the end of the production of the latter. The reference plane 5 defines, in effect, a bottom of printing chamber 3.

The 3D printer 1 also comprises a gas supply system 10 for feeding an inert gas and a reagent gas consisting of sulphur hexafluoride (SF₆) into the printing chamber 3 at various times during the operation of the 3D printer, as will be further explained below. Sulphur hexafluoride has a higher molar mass and specific gravity than those of air and in particular than those of the inert gas. In particular, the inert gas is nitrogen or argon. Preferably, the inert gas is nitrogen (N₂).

In particular, the printing chamber 3 comprises an inlet 11 and an outlet 12 for the aforementioned gases, located at substantially the same elevation, with respect to the reference plane 5. The printing chamber 3 comprises an additional outlet 13 located higher than the outlet 12. The gas supply system 10 is connected to the inlet 11 and outlets 12 and 13 via respective pipes.

With reference to FIG. 2, the supply system 10 comprises a pneumatic circuit 14, which is connected between the outlet 12 and inlet 11 and comprises, in the following order from the outlet 12 to the inlet 11, a filter assembly 15, a pump 16, two connectors 17 and 18 for an inert gas source and a sulphur hexafluoride source, respectively, and a delivery valve 19. The two connectors 17 and 18 are provided with two respective shut-off valves 20 and 21. The pneumatic circuit 14 further comprises a bypass branch 22, which comprises a bypass valve 21 and has a first end connected to the outlet 12 and the other end connected between the outlet of the pump 16 and the inlet of the delivery valve 19. The higher outlet 13 is connected to the filter assembly 15.

The filter assembly 15 comprises a cyclone 24 and a subsequent filter 25 to filter the gases circulating in the pneumatic circuit 14 to retain large particles and small particles, respectively. The outlet 13 is connected at a point in the pneumatic circuit 14 between the cyclone 24 and the filter 25.

The pneumatic circuit 14 comprises a plurality of pressure sampling points 26, 27, 28, 29, 30, 31. The pressure sampling point 26 is located between the outlet 12 and the filter assembly 15. The pressure sampling point 27 is located between the cyclone 24 and the filter 25. The pressure sampling point 28 is located between the filter 25 and the pump 16. The pressure sampling point 29 is located between the pump 16 and the group of connectors 17 and 18. The pressure sampling point 30 is located on the bypass branch 22 upstream of the bypass valve 23. The pressure sampling point 31 is located between the pressure valve 19 and the inlet 11, i.e. downstream of the pressure valve 19.

The 3D printer 1 comprises a control unit 32 for controlling the movement of the build plane 4, the feeder 6, the spreader 7, the laser head 8, the dust collection system 9 and the gas supply system 10. In particular, the control unit 32 is adapted to control the pump 16 and the valves 19, 20, 21, 23 according to pressure measurements taken in at least one of the pressure sampling points 26-31. For this purpose, the valves 19, 20, 21, 23 are solenoid valves.

The control unit 32 is configured to control the aforementioned devices and systems to enable the 3D printer to implement the method for producing a magnesium body by laser powder bed fusion 3D printing, described below.

First, the magnesium powder is pre-treated with hydrofluoric acid in a protected atmosphere to form a coating of magnesium fluoride (MgF₂) on the powder grains. In other words, before being fed to the 3 printing chambers and then used for 3D printing, the magnesium powder is treated to create the aforementioned magnesium fluoride coating on the powder grains. The protected atmosphere comprises argon or nitrogen. Preferably, the protected atmosphere comprises nitrogen (N₂).

Specifically, the pre-treatment of magnesium powder comprises the steps of mixing in a container a composition of a first amount by mass of magnesium powder and a second amount by volume of hydrofluoric acid and drying the mixed composition.

The feeder 6 and spreader 7 cooperate to feed pre-treated magnesium powder in successive layers onto the build plate 4. The laser head 8 sinters one layer of pre-treated magnesium powder at a time on the build plate 4 by emitting a laser beam, moving according to successive cross-sections of a given digital model loaded into the control unit 32.

The supply system 10 introduces and retains sulphur hexafluoride in the printing chamber 3 during sintering of the pre-treated magnesium powder so that the magnesium fluoride from the coating of the powder grains disperses into the molten magnesium produced by the sintering and the sulphur hexafluoride reacts with said molten magnesium to produce magnesium fluoride so that both the magnesium fluoride carried by the coating of the powder grains and that produced by the reaction of the magnesium hexafluoride disperse into the crystalline structure of the magnesium once the latter has solidified. The reaction occurs when sulphur hexafluoride is hit and ionised by the laser beam. Before feeding the magnesium powder into the printing chamber 3 and then before sintering the pre-treated magnesium powder on the build surface 4, inert gas is fed into the printing chamber 3 so that it circulates through the inlet 11 and outlet 12 to create an inert environment in the printing chamber 3, i. e. to remove any impurities and remove oxygen. For this purpose, the control unit 32 opens shut-off valve 17 and the delivery valve 19 and closes and bypass valve 23.

Subsequently, i.e. once the step of inerting the printing chamber 3 has been completed, the control unit 32 closes the shut-off valve 20 and opens the shut-off valve 21, while leaving the delivery valve 19 open and the bypass valve 23 closed in order to circulate the sulphur hexafluoride through the inlet 11 and the outlet 12 in order to supply the sulphur hexafluoride to the printing chamber 3 instead of the inert gas. In this way, due to the difference in molar mass and specific weight between the inert gas and the sulphur hexafluoride, at least some of the inert gas present in the printing chamber 3 progressively escapes from the highest outlet 13 and consequently the sulphur hexafluoride is arranged at the bottom of the printing chamber 3 creating a layer of sulphur hexafluoride above the reference plane 5.

When the pressure measured at the pressure sampling point 31 exceeds a certain PTH pressure threshold value, the control unit 32 closes the delivery valve 19, opens the bypass valve 23 and closes the shut-off valve 21 to terminate the supply of sulphur hexafluoride so that the sulphur hexafluoride already in the printing chamber 3 is retained there. At the same time, the control unit 32 opens the shut-off valve 20 to feed and circulate the inert gas in the part of the pneumatic circuit 14 that is closed on the bypass branch 22 to protect the printing chamber 3 from the outside atmosphere.

At this point, the control unit 32 activates the 3D printing process, i.e. it controls the feeder 6 and the spreader 7 to feed magnesium powder for successive layers onto the build plate 4 and it controls the laser head 8 to sinter one layer of pre-treated magnesium powder at a time on the build plate 4.

Thus, the solidified magnesium of the body produced by the 3D printing process is doped with magnesium fluoride. In contrast to the prior art in the field of laser powder bed fusion 3D printing, the 3D printing process of the invention takes place via the presence of a reactant gas, i.e. sulphur hexafluoride, in the printing chamber 3.

The extent of magnesium fluoride doping of the magnesium body produced by the 3D printing process is established by keeping an appropriate amount of inert gas together with sulphur hexafluoride in the printing chamber 3 during sintering of the pre-treated magnesium powder. By appropriately choosing the PTH pressure threshold value and, if necessary, the values of other parameters of the gas supply system 10, it is possible to modulate the amount of inert gas remaining in the printing chamber 3 before closing the delivery valve 19 and opening the bypass valve 23, and consequently it is possible to modulate the thickness of the sulphur hexafluoride layer deposited on the reference plane 5.

In order to have a sufficiently high probability of triggering the reaction between the sulphur hexafluoride and the molten magnesium, i.e. such that the magnesium fluoride reaches an appreciable concentration in the body produced by the 3D printing process, it is necessary that, at the end of the step of feeding sulphur hexafluoride feeding to the printing chamber 3, the sulphur hexafluoride layer reaches a thickness of minimum value above the reference plane 5. By way of example, the minimum thickness value is 20 mm.

Advantageously, the control unit 32 is configured to periodically perform a sulphur hexafluoride topping-up step by closing the shut-off valve and bypass valve 23 and opening the shut-off valve 21 and the delivery valve 19. In fact, the sulphur hexafluoride in the printing chamber 3 tends to be consumed by the reaction with the molten magnesium. The topping-up step is triggered, for example, depending on the pressure measured at the pressure sampling point 31.

According to a further embodiment, the magnesium fluoride doping extent of the magnesium body produced by the 3D printing process is established by optimising the pre-treatment of the magnesium powder and/or the feeding of sulphur fluoride into the printing chamber 3, so that the presence of inert gas in the printing chamber 3 during sintering is no longer necessary. In this case, the pressure threshold value PTH will be selected so that all the inert gas escapes from the printing chamber 3 while it is being filled with sulphur hexafluoride before sintering the pre-treated magnesium powder.

According to a further embodiment not illustrated, the frame 2 comprises at least one pneumatically sealed compartment, which houses, in addition to the printing chamber 3, the powder feeder 6, the laser head 8 and the powder collection system 9, and the pneumatic circuit 14 comprises a further branch connected in parallel to the bypass branch 22 to introduce and retain inert gas in this compartment in order to mitigate the risks due to the handling of magnesium, which is a highly flammable material.

The 3D printing method described above enables the creation of magnesium bodies doped with magnesium fluoride. Magnesium fluoride aids the capture and release of hydrogen by magnesium, improving performance compared to pure magnesium in terms of chemical reaction speed.

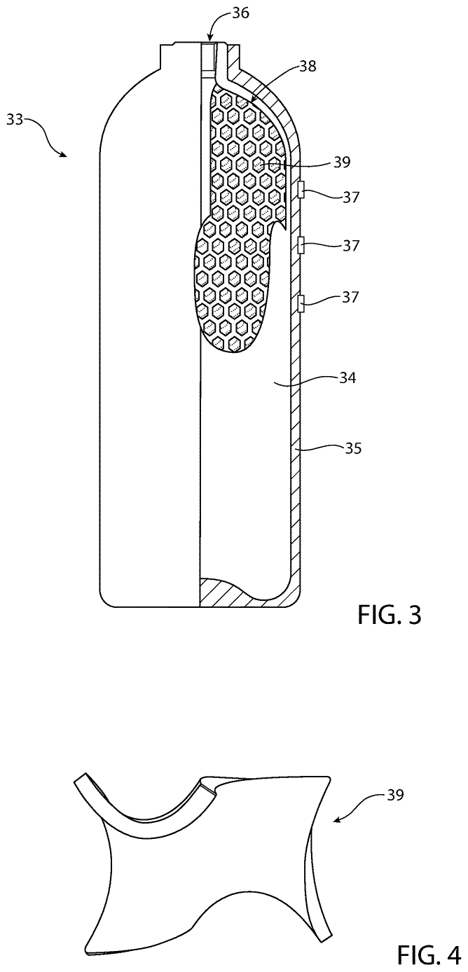

In FIGS. 3, 33 generically denotes a container for storing hydrogen in the solid state. The container comprises a storage body 34 made of metal for storing hydrogen in the form of metal hydride, a casing 35, which contains the storage body 34 and has an opening 36 for hydrogen injection and extraction in gaseous form, and at least one or more heating bands 37 arranged around the casing 35 for heating the storage body 34 to allow a chemical capture reaction and a chemical release reaction of the hydrogen.

The storage body 34 is made of magnesium so it stores hydrogen in the form of magnesium hydride. The magnesium of the storage body 34 is doped with magnesium fluoride. Such doping increases the rate of hydrogen capture and release by the storage body 34.

The storage body 34 has a three-dimensional lattice structure 38 defined by a plurality of elementary cells 39 having the same shape as a three-dimensional gyroid. The lattice structure 38 is defined by a multiple repetition of the elementary cell 38 such that it saturates the total volume of the storage body 34. In FIG. 3, the lattice structure 38 is illustrated in simplified form. FIG. 4 illustrates an example of elementary cell 39 of the lattice structure in FIG. 3.

The storage body 34 is made according to the laser powder bed fusion 3D printing method described above from a digital model of the lattice structure 38 which consists of a repetition, in the volume of the storage body 34, of the digital model of the elementary cell 39. The example of elementary cell 39 in FIG. 4 is defined by a mathematical function.

The elementary cell 39 in FIG. 4 has a high ratio of exposed surface area to footprint volume. Furthermore, the dimensions of the elementary cell 39 are selected according to the compromise between the high number of repetitions required to saturate the volume of the storage body 34, so as to increase the surface area that will come into contact with the gaseous hydrogen fed into the container 33, and the structural strength of the storage body 34. It should be remembered, in fact, that the formation of magnesium hydride in a magnesium body does not go very deep with respect to the surface of the magnesium body being exposed to hydrogen. The high ratio of exposed surface area to overall volume of the elementary cell 39 and its high number of repetitions (hence the small size of the elementary cell 39) increase the available surface area within the storage body 34 for capturing hydrogen in the form of magnesium hydride and consequently increase the storage capacity of the container 33.

By way of example, the elementary cell 39 in FIG. 4 has a footprint volume equal to a cube with a side of 10 mm and is 2 mm thick.

Preferably, the casing 35 is made of steel.

According to a further embodiment not illustrated, the heating bands 37 are integrated into the thickness of the casing 35.

The main advantage of the method for producing a magnesium body by laser powder bed fusion 3D printing described above is to enable the production of magnesium bodies doped with magnesium fluoride with a high exposed surface area per footprint volume. This makes it possible to produce a storage body 34 for a container 33 to store hydrogen in the solid state with a high storage capacity. In addition, doping the magnesium with sulphur fluoride allows a higher rate of hydrogen capture and release.

It follows that the container 33 has a twofold advantage over solid-state hydrogen storage containers: a greater hydrogen storage capacity, due to the large exposed surface area per volume of the 3D-printed storage body 34, and greater ease of use, due to the increased hydrogen capture and release rate achieved by doping the magnesium with sulphur fluoride.

In addition, the pre-treatment of the magnesium powder has the advantage of making it easier and cheaper to handle. The magnesium fluoride coating of the powder grains makes magnesium powders less dangerous, as pure magnesium in powder form is easily flammable.

1. A container for storing hydrogen in a solid state, the container (33) comprising a storage body (34) of metal for storing hydrogen in the form of metal hydride, a casing (35), which contains the storage body (34) and has an opening (36) for hydrogen injection and extraction in gaseous form, and at least one heating band (37) arranged in the thickness of the casing (35) or around the casing (35) for heating the storage body (34) so as to allow a chemical capture reaction and a chemical release reaction of the hydrogen by the storage body (34); said storage body (34) being made of magnesium doped with magnesium fluoride and having a lattice structure (38) defined by a plurality of elementary cells (39) having the same shape as a three-dimensional gyroid.

2. The container according to claim 1, wherein said casing (35) is made of steel.

3. The container according to claim 1, wherein said storage body (34) is made by laser powder bed fusion 3D printing.
